(19) United States
(12) Patent Application Publication
(10) Pub. No.: US 2026/0299206 A1
(43) Pub. Date: Oct. 1, 2026

(54) OPTICAL OUTPUT MODULE, OPTICAL ELEMENT, AND METHOD FOR CONTROLLING OPTICAL OUTPUT MODULE

(71) Applicant: NEC Corporation, Tokyo (JP)

(72) Inventor: Naoki KOBAYASHI, Tokyo (JP)

(73) Assignee: NEC Corporation, Tokyo (JP)

(21) Appl. No.: 19/564,559

(22) Filed: Mar. 12, 2026

(30) Foreign Application Priority Data
Mar. 25, 2025 (JP) 2025-050413

(51) Int. Cl. G02B 6/293

(52) U.S. Cl. CPC G02B 6/29338; G02B 6/29395

(57) ABSTRACT

An optical output unit outputs first light. An optical element outputs second light obtained by performing wavelength filtering on the first light input from the optical output unit. The optical element includes a wavelength filter that performs wavelength filtering on the first light and outputs the second light, an optical waveguide that guides the first light to the wavelength filter and outputs the second light from the wavelength filter as output light, and a heater that is provided for the optical waveguide and controls reflected light generated in the optical waveguide.

### INCORPORATION BY REFERENCE

This application is based upon and claims the benefit of priority from Japanese patent application No. 2025-050413, filed on Mar. 25, 2025, the disclosure of which is incorporated herein in its entirety by reference.

### TECHNICAL FIELD

The present disclosure relates to an optical output module, an optical element, and a method for controlling the optical output module.

### BACKGROUND ART

Various kinds of optical modules are used in an optical communication network. Such optical modules are provided with an optical circuit including an optical waveguide that propagates light. In a case where light is guided by the optical waveguide, undesirable reflected light may be likely to be generated. Therefore, various approaches for mitigating the influence of the reflected light in the optical circuit have been proposed.

For example, International Patent Publication No. WO 2013/133099 proposes a technique of canceling reflected light by multiplexing two beams of the reflected light with phases opposite to each other. In this configuration, light propagating through one optical waveguide is branched into two branched optical waveguides. One of the two branched optical waveguides is provided with a phase adjustment unit. By adjusting the phase of the reflected light generated in one branched optical waveguide with the phase adjustment unit, the reflected light returned from the two branched optical waveguides is multiplexed in opposite phases. Consequently, the reflected light can be canceled.

### SUMMARY

Meanwhile, in an optical transmitter used in an optical communication network, a wavelength-tunable light source that performs wavelength filtering on light output from a semiconductor optical amplifier with a wavelength filter configured as a Silicon (Si) photonics element is used. In such a wavelength-tunable light source, laser oscillation may sometimes become unstable due to reflected light of light entering the Si photonics element.

However, the technique of canceling the reflected light from two branched optical waveguides as in International Patent Publication No. WO 2013/133099 can be applied only to an optical circuit having a specific configuration. Since the technique described in International Patent Publication No. WO 2013/133099 can be applied only to light having a specific wavelength, it is not practicable to apply the technique to a wavelength-tunable light source in which the wavelength of light changes.

An optical output module according to one example aspect of the present disclosure includes an optical output means for outputting first light and an optical element that outputs second light obtained by performing wavelength filtering on the first light input from the optical output means, in which the optical element includes a wavelength filter that performs wavelength filtering on the first light and outputs the second light, an optical waveguide that guides the first light to the wavelength filter and outputs the second light from the wavelength filter as output light, and a heater that is provided for the optical waveguide and controls reflected light generated in the optical waveguide.

An optical element according to one example aspect of the present disclosure includes a wavelength filter that outputs second light obtained by performing wavelength filtering on first light input from an optical output means, an optical waveguide that guides the first light to the wavelength filter and outputs the second light from the wavelength filter as output light, and a heater that is provided for the optical waveguide and controls reflected light generated in the optical waveguide.

A method for controlling an optical output module according to one example aspect of the present disclosure includes, in the optical output module that guides, with an optical waveguide, first light input from an optical output means to a wavelength filter and outputs second light from the wavelength filter as output light, performing, by the wavelength filter, wavelength filtering on the first light input from the optical output means and outputting the second light, and controlling, by a heater provided for the optical waveguide, reflected light generated in the optical waveguide.

According to the present disclosure, an optical output module, an optical element, and a method for controlling the optical output module that can suppress influence of reflected light in an optical waveguide can be provided with a simple configuration.

### BRIEF DESCRIPTION OF THE DRAWINGS

FIG. 1 is a top view schematically illustrating a configuration of a wavelength-tunable light source according to one example embodiment;

FIG. 2 is a top view schematically illustrating a configuration of a wavelength-tunable light source according to one example embodiment;

FIG. 3 is a top view schematically illustrating a configuration of a wavelength-tunable light source according to one example embodiment; and

FIG. 4 is a top view schematically illustrating a configuration of a wavelength-tunable light source according to one example embodiment.

### EXAMPLE EMBODIMENT

Hereinafter, example embodiments of the present disclosure will be described with reference to the drawings. In the drawings, the same elements are denoted by the same reference signs, and redundant description will be omitted as necessary.

Hereinafter, the term “one example embodiment” implies that it is applicable to any of the example embodiments described below or a combination of two or more example embodiments and the application is not limited to a specific example embodiment.

### First Example Embodiment

A wavelength-tunable light source according to a first example embodiment will be described. An optical element according to the present example embodiment is an element including an optical circuit that performs wavelength filtering on light input from an external light emitting element and outputs light having a predetermined wavelength to an external optical amplifier. The optical element according to the present example embodiment may be configured as a silicon photonics (SiP) element formed on a silicon on insulator (SOI) substrate, for example.

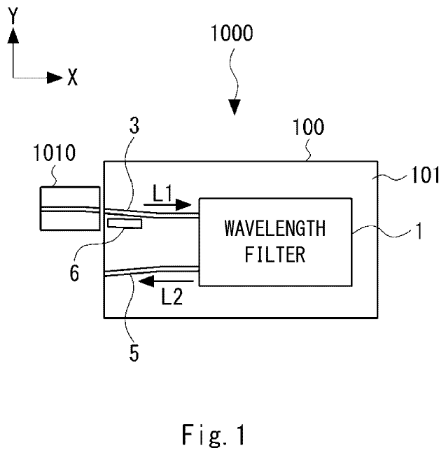

FIG. 1 is a top view schematically illustrating a configuration of a wavelength-tunable light source according to one example embodiment. A wavelength-tunable light source 1000 is configured as an optical output module including at least an optical element 100 and a light emitting element 1010. The light emitting element 1010 may be configured as, for example, a semiconductor optical amplifier.

Hereinafter, in the drawings, an X axis and a Y axis in a two-dimensional orthogonal coordinate system are displayed for clarity of description. In the drawings, the horizontal direction to the right in the drawings is defined as an X-axis direction. The upward vertical direction in the drawings is defined as a Y-axis direction. An end face 110 of the optical element 100, end faces 1011 and 1012 of the light emitting element 1010, and end faces 1021 and 1022 of an optical amplifier 1020 are faces perpendicular to the X-axis direction.

The light emitting element 1010 outputs light L1 to the optical element 100. In the optical element 100, the light L1 is input to a wavelength filter 1 via an optical waveguide 3. The wavelength filter 1 performs wavelength filtering on the light L1 in such a way as to allow only a wavelength in a predetermined band to pass. Then, light L2 after wavelength filtering by the wavelength filter 1 is output via an optical waveguide 5. Hereinafter, the light L1 and the light L2 are also referred to as first light and second light, respectively.

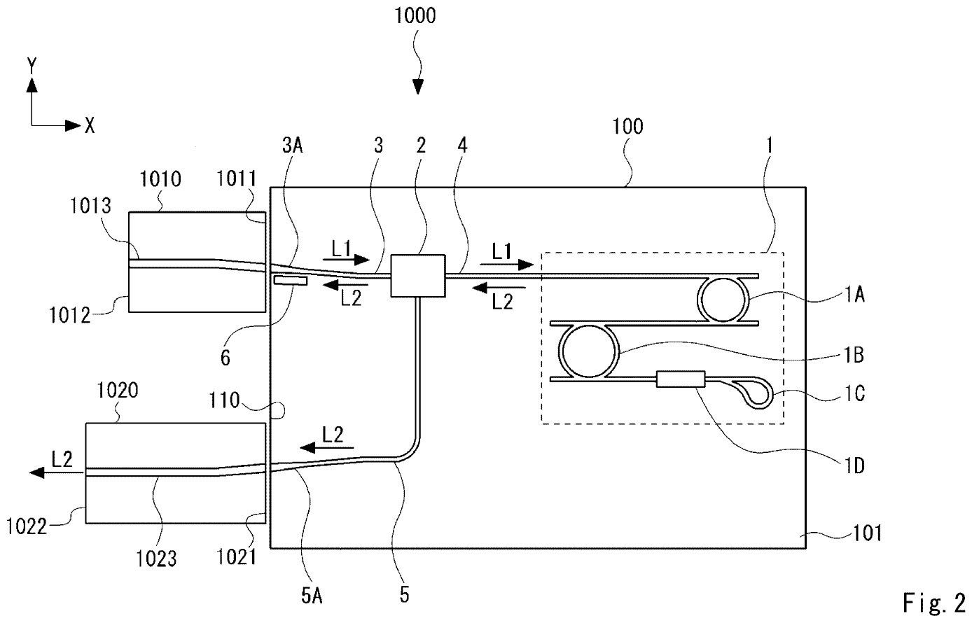

The configuration of the wavelength-tunable light source 1000 will be described in more detail. FIG. 2 is a top view schematically illustrating a configuration of a wavelength-tunable light source according to one example embodiment. FIG. 2 illustrates a configuration example in which the optical amplifier 1020 is further provided in the wavelength-tunable light source 1000. The optical amplifier 1020 may be configured as, for example, a semiconductor optical amplifier.

The light emitting element 1010 is provided with an optical waveguide 1013 extending between the end faces 1011 and 1012. An antireflection film (not illustrated) is formed on the end face 1011 of the light emitting element 1010 facing the end face 110 of the optical element 100. A highly reflective film (not illustrated) is formed on the end face 1012 opposite to the end face 1011. The optical waveguide 1013 has a portion inclined by a predetermined angle with respect to the end face 1011 in the vicinity of the end face 1011 in order to prevent influence of reflection of light on the end face 1011. In this example, the optical waveguide 1013 is inclined clockwise by a predetermined angle with respect to the X-axis direction in the vicinity of the end face 1011. The optical waveguide 1013 is provided with a gain region. In the light emitting element 1010, for example, light is emitted by injecting a current into the gain region of the optical waveguide 1013, whereby the light L1 is guided by the optical waveguide 1013. The light L1 guided by the optical waveguide 1013 is output from the end face 1011 to the optical element 100.

The optical amplifier 1020 is provided with an optical waveguide 1023 extending between the end faces 1021 and 1022. An antireflection film (not illustrated) is formed on the end face 1021 of the optical amplifier 1020 facing the end face 110 of the optical element 100. An antireflection film (not illustrated) is also formed on the end face 1022 opposite to the end face 1021. The optical waveguide 1023 has a portion inclined by a predetermined angle with respect to the end face 1021 in the vicinity of the end face 1021 in order to prevent influence of reflection on the end face 1021 of the light L2 output from the optical waveguide 5 of the optical element 100. In this example, the optical waveguide 1023 extends in a direction inclined counterclockwise by a predetermined angle with respect to the X-axis direction. The optical waveguide 1023 is provided with a gain region. In the optical amplifier 1020, for example, carriers in an excited state are produced by injecting a current into the gain region of the optical waveguide 1023. As a result, the light L2 guided by the optical waveguide 1023 is amplified to a desired intensity. The amplified light L2 is output from the end face 1022 to the outside.

Next, the optical element 100 according to the present example embodiment will be described. FIG. 2 is a diagram schematically illustrating a configuration of an optical element according to one example embodiment. The optical element 100 includes the wavelength filter 1, an optical branch unit 2, the optical waveguides 3 to 5, and a heater 6. Hereinafter, the optical waveguide 3 will also be referred to as a first optical waveguide. The optical waveguide 4 will also be referred to as a third optical waveguide. The optical waveguide 5 will also be referred to as a second optical waveguide.

The wavelength filter 1, the optical branch unit 2, and the optical waveguides 3 to 5 are formed on a substrate 101. In a case where the optical element 100 is configured as a SiP element, the substrate 101 is configured as an SOI substrate. The optical waveguides 3 to 5 are configured as, for example, silicon optical waveguides.

The optical waveguide 3 extends between the end face 110 and the optical branch unit 2 in such a way as to have a portion inclined clockwise by a predetermined angle with respect to the X-axis direction. The optical waveguide 3 may also be provided with a spot size converter 3A in order to improve coupling efficiency with the optical waveguide 1013 of the light emitting element 1010. The spot size converter 3A is configured as an optical waveguide whose width decreases from the end face 110 toward the optical branch unit 2. Hereinafter, the spot size converter 3A will also be referred to as a first spot size converter. The optical waveguide 3 guides the light L1 output from the light emitting element 1010 to the optical branch unit 2.

The wavelength filter 1 and the optical branch unit 2 are connected by the optical waveguide 4. The optical branch unit 2 is configured as, for example, a directional coupler. The optical branch unit 2 outputs the light L1 input from the optical waveguide 3 to the optical waveguide 4. The optical branch unit 2 branches the light L2 that is input through the optical waveguide 4 and has been wavelength-filtered by the wavelength filter 1 into the optical waveguides 3 and 5. The light L2 branched into the optical waveguide 5 is output as output light from the end face 110 to the optical amplifier 1020.

The wavelength filter 1 performs wavelength filtering on the light L1 input from the optical waveguide 4 and outputs the light L2 in a predetermined band to the optical waveguide 4. The wavelength filter 1 may be configured as, for example, a wavelength filter having a general double ring resonator structure. In this example, the effective refractive index of the optical waveguide is adjusted by applying a voltage to a phase modulation unit provided in the optical waveguide forming the ring resonator or driving a heater provided in the vicinity of the ring resonator. As a result, the resonance state of the light can be controlled to control the wavelength of the oscillating light to a desired wavelength.

A configuration example of the wavelength filter 1 will be described. In the example in FIG. 2, in the wavelength filter 1, two ring resonators 1A and 1B having different circumferential lengths are cascade-connected. The light L1 input from the optical waveguide 4 passes through the ring resonators 1A and 1B and then is folded back at a loop mirror 1C. The folded light passes through the ring resonators 1A and 1B. At this time, the light passing through the ring resonators 1A and 1B is light in a predetermined band that has been wavelength-filtered by a so-called Vernier effect. A phase modulation unit 1D is provided between the ring resonator 1B and the loop mirror 1C. In the wavelength filter 1, the wavelength of transmitted light is controlled by the phase modulation unit 1D and heaters (not illustrated) provided in the ring resonators 1A and 1B. Then, the light L2 after wavelength filtering returns to the optical branch unit 2 via the optical waveguide 4.

The light L2 is branched by the optical branch unit 2, and a part of the light L2 returns to the light emitting element 1010. As a result, an optical resonator is configured between the end face 1022 of the light emitting element 1010 on which the highly reflective film is formed, and the loop mirror 1C of the wavelength filter 1.

The optical waveguide 5 extends between the end face 110 and the optical branch unit 2 in such a way as to have a portion inclined counterclockwise by a predetermined angle with respect to the X-axis direction. The optical waveguide 5 may also be provided with a spot size converter 5A in order to improve coupling efficiency with the optical waveguide 1023 of the optical amplifier 1020. The spot size converter 5A is configured as an optical waveguide whose width decreases from the end face 110 toward the optical branch unit 2. Hereinafter, the spot size converter 5A will also be referred to as a second spot size converter. The optical waveguide 5 outputs the light L2 output from the optical branch unit 2 to the optical amplifier 1020.

In the optical element 100, a part of light propagating through the optical components such as the wavelength filter 1 and the optical branch unit 2 provided in the optical element 100 and the optical waveguides 3 to 5 is reflected by these optical components and optical waveguides. Due to the influence of the reflected light generated by the above, a resonance state of light inside the optical element is affected. As a consequence, an undesirable wavelength is included in the light L2, and a noise component may be likely to appear in a spectrum.

To cope with this, in the optical element 100, the heater 6 is provided in the vicinity of the spot size converter 3A of the optical waveguide 3. Hereinafter, the heater 6 will also be referred to as a first heater. The spot size converter 3A has a tapered shape in which the width narrows as light propagates. Therefore, depending on the tapered shape design, reflected light of the light L1 may be sometimes generated in the spot size converter 3A. However, the optical element 100 can heat the spot size converter 3A by applying power W1 to the heater 6 in the vicinity of the spot size converter 3A. As a result, the effective refractive index of the spot size converter 3A can be controlled. As a consequence, the influence of the reflected light on the resonance state of the light can be suppressed by controlling the phase of the reflected light of the light L1 in the spot size converter 3A.

For example, in a case where reflected light of the light L1 is generated in the spot size converter 3A, the reflected light may be likely to be input to the light emitting element 1010. In this case, since the reflected light reciprocates in the optical resonator between the light emitting element 1010 and the wavelength filter 1, an undesirable wavelength peak attributable to the reflected light may be likely to occur in the spectrum of the light L2 that is output light.

On the other hand, in the present configuration, the optical waveguide 3 is heated by the heater 6 in such a way that the reflected light of the light L1 generated in the spot size converter 3A and the reflected light returning to the spot size converter 3A after entering the light emitting element 1010 have opposite phases to each other. As a result, the reflected light generated in the spot size converter 3A can be canceled. Consequently, the intensity of an undesirable wavelength component in the spectrum of the light L2 can be suppressed to a predetermined intensity or less.

As described above, in the optical element 100, by applying appropriate power W1 to the heater 6 to heat the optical waveguide 3 provided in the optical element 100, the effective refractive index of the optical waveguide 3 heated by the heater 6 can be controlled. As a result, a noise component of the spectrum of the light L2 due to the reflected light in the optical waveguide 3 can be efficiently suppressed.

As described above, according to the present configuration, by controlling the effective refractive index of the optical waveguide with the power applied to the heater provided for the optical waveguide of the optical element, the influence of the reflected light in the optical waveguide on the resonance state of the light can be effectively suppressed with a simple configuration.

### Second Example Embodiment

In the first example embodiment, the optical element 100 that cancels the reflected light of the light L1 generated in the spot size converter 3A by heating the spot size converter 3A with the heater 6 has been described. Meanwhile, in order to effectively suppress the reflected light of the light L1 in the spot size converter 3A, it is required to control the power W1 applied to the heater 6. Thus, in the present example embodiment, a wavelength-tunable light source capable of suitably controlling the power W1 applied to the heater 6 will be described.

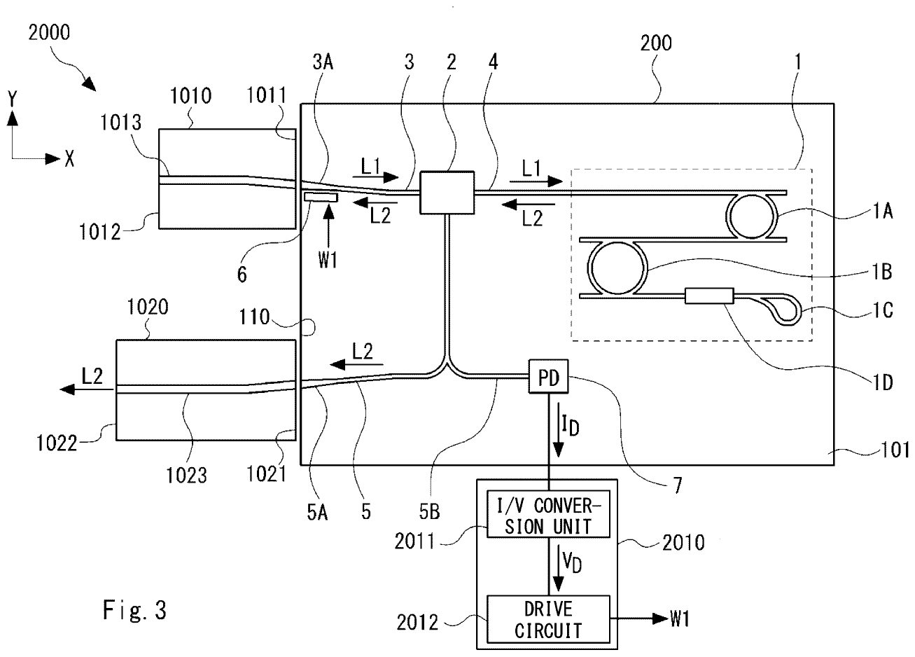

FIG. 3 is a top view schematically illustrating a configuration of a wavelength-tunable light source according to one example embodiment. In a wavelength-tunable light source 2000, the optical element 100 of wavelength-tunable light source 1000 according to the first example embodiment is replaced with an optical element 200. The wavelength-tunable light source 2000 further includes a heater control unit 2010 as compared with the wavelength-tunable light source 1000 according to the first example embodiment.

The optical element 200 is further provided with an optical waveguide 5B and a photodetector (PD) 7 as compared with the optical element 100. The optical waveguide 5B is an optical waveguide branched from an optical waveguide 5. The optical waveguide 5B branches a part of light L2 propagating through the optical waveguide 5B to the photodetector 7.

The photodetector 7 is configured as a photodiode formed on a substrate 101. The photodetector 7 detects a part of the light L2 input from the optical waveguide 5B. Then, the photodetector 7 outputs a current signal I_{D} indicating the intensity of the part of the input light L2 to the heater control unit 2010.

The heater control unit 2010 includes a current-voltage conversion unit (I/V conversion unit) 2011 and a drive circuit 2012. The I/V conversion unit 2011 converts the current signal I_{D} into a voltage signal V_{D}. The I/V conversion unit 2011 outputs the voltage signal V_{D} to the drive circuit 2012. The I/V conversion unit 2011 may be configured using, for example, a lock-in amplifier.

The drive circuit 2012 controls the power W1 applied to a heater 6 according to the voltage signal V_{D} in such a way that the resonance state of light in the optical resonator configured between a wavelength filter 1 and a light emitting element 1010 becomes a suitable state. As a result, the power W1 applied to the heater 6 can be controlled in such a way as to suppress a noise component in the spectrum of the light L2. By continuously monitoring the light L2, feedback control of the power W1 applied to the heater 6 can also be performed in such a way that the resonance state of light becomes a suitable state.

### Third Example Embodiment

In the first and second example embodiments, the optical elements in which the heater 6 is provided in the vicinity of the spot size converter 3A have been described. However, the installation position of the heater in the optical element is not limited thereto. Hereinafter, an optical element in which heaters are further installed at different positions will be described.

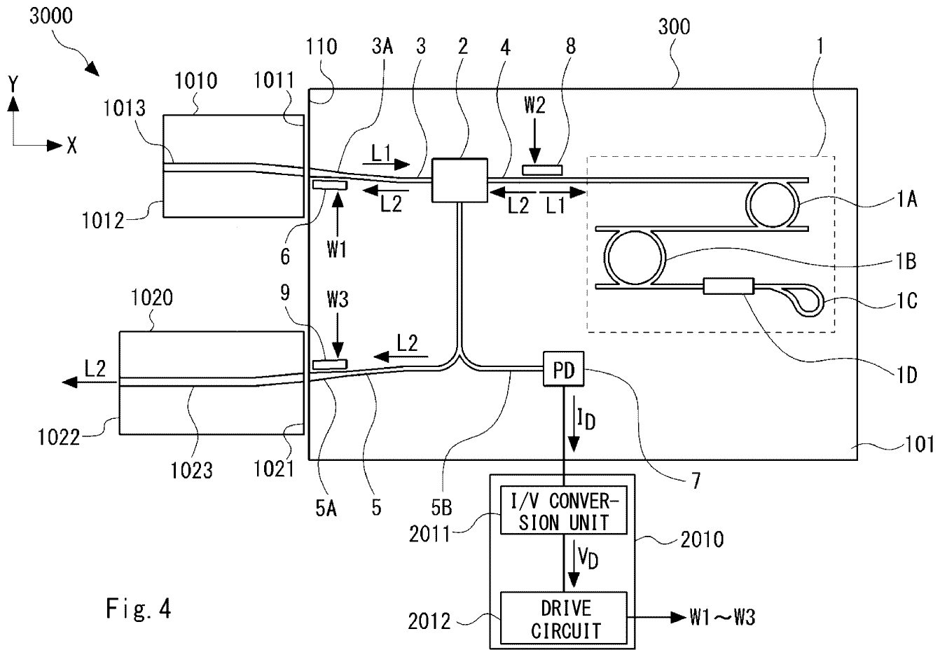

FIG. 4 is a top view schematically illustrating a configuration of an optical element according to one example embodiment. An optical element 300 is further provided with heaters 8 and 9 as compared with the optical element 200 according to the second example embodiment. Hereinafter, the heater 8 will also be referred to as a third heater. The heater 9 will also be referred to as a second heater.

The heater 8 is provided in the vicinity of an optical waveguide 4. Accordingly, the influence of the reflected light of light propagating through the optical waveguide 4 can be suppressed by applying suitable power W2 to the heater 8.

The heater 9 is provided in the vicinity of a spot size converter 5A of an optical waveguide 5. Accordingly, by applying suitable power W3 to the heater 9, for example, the influence of the reflected light of the light L2 generated in the spot size converter 5A can be suppressed.

As described above, by providing the heater in the vicinity of each of the optical waveguides to which optical components are connected in the optical element, the influence of the reflected light generated in each of the optical waveguides on the resonance state of light can be more effectively suppressed.

In the present example embodiment, the optical element 300 provided with the three heaters 6, 8, and 9 has been described, but this is merely illustrative. Only one or two of the heaters 6, 8, and 9 may be provided in the optical element. Each of the heaters 6, 8, and 9 may be provided by being divided into two or more heaters. Furthermore, in a case where there is an optical waveguide (not illustrated) other than the optical waveguides 3 to 5, a heater similar to the heaters 6, 8, and 9 may be provided in the vicinity of the optical waveguide (not illustrated).

### Other Example Embodiments

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

The configurations of the wavelength filters 1 in the above-described example embodiments are merely examples, and the wavelength filters 1 may have another configuration as long as wavelength filtering can be performed on the light L1 and the light L2 in a predetermined band can be output to the optical waveguide 4.

In the second and third example embodiments, a case where the photodetector 7 is mounted on the optical element has been described, but this is merely illustrative. For example, the photodetector 7 may be provided outside the optical element and receive the light L2 output from the optical amplifier 1020.

Each of the drawings is merely illustrative to describe one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings to describe illustrative example embodiments are not necessarily mandatory, and some features or steps may be omitted. The order of the steps described in any of the drawings may be changed as appropriate.

Some or all of the above example embodiments may also be described as the following Supplementary Notes, but are not limited to the following.

### Supplementary Note 1

An optical output module including:
an optical output means for outputting first light; and
an optical element that outputs second light obtained by performing wavelength filtering on the first light input from the optical output means,
in which the optical element includes:
a wavelength filter that performs wavelength filtering on the first light and outputs the second light;
an optical waveguide that guides the first light to the wavelength filter and outputs the second light from the wavelength filter as output light; and
a heater that is provided for the optical waveguide and controls reflected light generated in the optical waveguide.

### Supplementary Note 2

The optical output module according to Supplementary Note 1, in which the optical waveguide is heated by the heater in such a way that an undesirable wavelength component contained in the second light is suppressed to a predetermined intensity or less.

### Supplementary Note 3

The optical output module according to Supplementary Note 1 or 2, in which
the optical waveguide is provided with a spot size converter that reduces a spot size of the first light input from the optical output means, and
the heater is provided for the spot size converter.

### Supplementary Note 4

The optical output module according to Supplementary Note 1 or 2, further including:
a first optical waveguide that is the optical waveguide and guides the first light input from the optical output means, and a second optical waveguide that is the optical waveguide and outputs the second light that has been wavelength-filtered to an outside; and
an optical branch means for outputting the first light input via the first optical waveguide to the wavelength filter and branching the second light input from the wavelength filter into the first optical waveguide and the second optical waveguide.

### Supplementary Note 5

The optical output module according to Supplementary Note 4, in which
the first optical waveguide is provided with a first spot size converter that reduces a spot size of the first light input from the optical output means, and
a first heater that is the heater is provided for the first spot size converter.

### Supplementary Note 6

The optical output module according to Supplementary Note 4 or 5, in which
the second optical waveguide is provided with a second spot size converter that enlarges a spot size of the second light, and
a second heater that is the heater is provided for the second spot size converter.

### Supplementary Note 7

The optical output module according to any one of Supplementary Notes 4 to 6, further including a third optical waveguide that is the optical waveguide and connects between the optical branch means and the wavelength filter,
in which a third heater that is the heater is provided for the third optical waveguide.

### Supplementary Note 8

The optical output module according to any one of Supplementary Notes 1 to 7, further including:
a light detection means for detecting the second light; and
a control means for controlling power applied to the heater, according to a detection result on the second light by the light detection means, in such a way that the undesirable wavelength component contained in the second light becomes smaller than the predetermined intensity.

### Supplementary Note 9

An optical element including:
a wavelength filter that outputs second light obtained by performing wavelength filtering on first light input from an optical output means;
an optical waveguide that guides the first light to the wavelength filter and outputs the second light from the wavelength filter as output light; and
a heater that is provided for the optical waveguide and controls reflected light generated in the optical waveguide.

### Supplementary Note 10

A method for controlling an optical output module, the method including:
in the optical output module that guides, with an optical waveguide, first light input from an optical output means to a wavelength filter and outputs second light from the wavelength filter as output light,
performing, by the wavelength filter, wavelength filtering on the first light input from the optical output means and outputting the second light; and
controlling, by a heater provided for the optical waveguide, reflected light generated in the optical waveguide.

Some or all of the elements (such as configurations and functions, for example) described in Supplementary Notes 2 to 8 dependent on Supplementary Note 1 may be dependent on Supplementary Notes 9 and 10 as well with dependent relationships similar to those of Supplementary Notes 2 to 8. Some or all of the elements described in any supplementary note may be applied to various types of hardware, software, recording means for recording software, systems, and methods.

1. An optical output module comprising:
an optical output unit that outputs first light; and
an optical element that outputs second light obtained by performing wavelength filtering on the first light input from the optical output unit,
wherein the optical element comprises:
a wavelength filter that performs wavelength filtering on the first light and outputs the second light;
an optical waveguide that guides the first light to the wavelength filter and outputs the second light from the wavelength filter as output light; and
a heater that is provided for the optical waveguide and controls reflected light generated in the optical waveguide.

2. The optical output module according to claim 1, wherein the optical waveguide is heated by the heater in such a way that an undesirable wavelength component contained in the second light becomes smaller than a predetermined intensity.

3. The optical output module according to claim 1, wherein
the optical waveguide is provided with a spot size converter that reduces a spot size of the first light input from the optical output unit, and
the heater is provided for the spot size converter.

4. The optical output module according to claim 1, further comprising:
a first optical waveguide that is the optical waveguide and guides the first light input from the optical output unit, and a second optical waveguide that is the optical waveguide and outputs the second light that has been wavelength-filtered to an outside; and
an optical branch unit that outputs the first light input via the first optical waveguide to the wavelength filter and branching the second light input from the wavelength filter into the first optical waveguide and the second optical waveguide.

5. The optical output module according to claim 4, wherein
the first optical waveguide is provided with a first spot size converter that reduces a spot size of the first light input from the optical output unit, and
a first heater that is the heater is provided for the first spot size converter.

6. The optical output module according to claim 4, wherein
the second optical waveguide is provided with a second spot size converter that enlarges a spot size of the second light, and
a second heater that is the heater is provided for the second spot size converter.

7. The optical output module according to claim 4, further comprising a third optical waveguide that is the optical waveguide and connects between the optical branch unit and the wavelength filter,
wherein a third heater that is the heater is provided for the third optical waveguide.

8. The optical output module according to claim 2, further comprising:
a photodetector that detects the second light; and
a control unit that controls power applied to the heater, according to a detection result on the second light by the photodetector, in such a way that the undesirable wavelength component contained in the second light becomes smaller than the predetermined intensity.

9. An optical element comprising:
a wavelength filter that outputs second light obtained by performing wavelength filtering on first light input from an optical output unit;
an optical waveguide that guides the first light to the wavelength filter and outputs the second light from the wavelength filter as output light; and
a heater that is provided for the optical waveguide and controls reflected light generated in the optical waveguide.

10. A method for controlling an optical output module, the method comprising:
in the optical output module that guides, with an optical waveguide, first light input from an optical output unit to a wavelength filter and outputs second light from the wavelength filter as output light,
performing, by the wavelength filter, wavelength filtering on the first light input from the optical output unit and outputting the second light; and
controlling, by a heater provided for the optical waveguide, reflected light generated in the optical waveguide.
